(19) United States
(12) Patent Application Publication
(10) Pub. No.: US 2009/0065452 A1
(43) Pub. Date: Mar. 12, 2009

(54) Document Sorting Apparatus With Multiple-Position Wire Divider Members

(75) Inventor: Aaron W. Smith, Plainfield, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SANFORD, L.P., Oak Brook, IL (US)

(21) Appl. No.: 11/854,254

(22) Filed: Sep. 12, 2007

(51) Int. Cl. B42F 7/00

(52) U.S. Cl. 211/11; 211/45

(57) ABSTRACT

A document sorting apparatus includes a base having a pair of parallel side rail members with apertures therein, the apertures distributed in a linear fashion along the length of the side rail members and each aperture in one of the side rail members aligned with a corresponding aperture in the opposite side rail member. Veins in the form of wire divider members are pivotally received in each pair of corresponding apertures. Segments of the wire divider members rest on a top surface of the side rail members when the wire divider member is in a rearwardly-inclined or forwardly-inclined position. The side rail members are provided with lateral extensions having ridges that secure the wire divider members in a vertical position by impeding the wire divider member from pivoting to inclined positions. The impedence of the ridges may be overcome with a deliberate application of force to the wire divider member.

### BACKGROUND

1. Field of the Disclosure

This disclosure relates generally to document organizational devices and, more particularly, to a desktop sorting device for file folders, envelopes, letters, photographs, and other documents having a plurality of regions for supporting and retaining documents, wherein the regions are separated from one another by divider members and the divider members are movable among a plurality of positions to facilitate access a desired one of the regions to view documents, add documents to, or retrieve documents from the desired region of the sorting device.

2. Description of the Related Art

Document file organizers are typically static in use and are designed to hold papers and file folders within a vertical, horizontal or angled linear pattern of dividers or sorting veins. The dividers are typically parallel to one another to keep the folders in an organized line and to prevent the folders from opening or to prevent paper documents from fanning or falling over. Such static document dividers prevent users from viewing the contents of stored documents or files without first removing the contents from between the dividers.

Existing document sorting organizers having pivoting sorting veins offer the ability to view documents stored between the sorting veins in desired segments of the organizers. However, the sorting veins of such existing organizers are difficult or impossible for the consumer to remove, as may be desired for storage of, e.g., thick files. Also, the sorting veins of these existing organizers are not securable in a vertical orientation.

### SUMMARY OF THE DISCLOSURE

A document sorting apparatus of the present disclosure has a plurality of discrete regions for supporting and retaining documents. The regions are separated from one another by movable wire divider members, which serve both to support documents in a particular region and to segregate or partition off documents in adjacent regions from one another. Each of the wire divider members is preferably securable in a plurality of positions to facilitate access to a desired one of the regions to view documents, add documents to, or retrieve documents from the desired region of the sorting device.

Each of the wire divider members preferably forms an inverted U-shape (which could be a block-U or inverted rounded-U shape), with inverted block-question mark-shaped portions at their lower ends that point inwardly toward one another. Two spaced-apart parallel rail members define the sides of a base of the document sorting apparatus. Each of the side rail members has a plurality of apertures spaced in a linear fashion along the length of the rail member. Each of the apertures in one of the rail members is aligned with a corresponding aperture in the other rail member. A horizontal end segment at the bottom of the inverted question mark-shaped portion is pivotably received in one of apertures.

Each of the side rail members preferably includes a laterally-extending projection above each of the apertures. Each of the laterally-extending projections includes a vertically-extending concave depression, i.e. a vertically-oriented dip bounded by a pair of ridges or bumps. The ridges of the laterally-extending projections project away from an outer surface of the rail members a sufficient distance to interfere with, but not completely prevent, movement of the wire divider members from one position to another. The vertically-extending concave depression of the laterally-extending projection accepts a segment of the block-question mark-shaped portion of the wire divider member that extends orthogonal to the horizontal end segment The ridges bounding the concave depression serve to secure the wire divider member in a vertical orientation.

In a preferred embodiment, each of the side rail members includes an elongate upper lip along a top edge of the side rail member, extending substantially the length of the side rail member, and in a direction toward the opposing side rail member. The elongate upper lips along the top edge of the side rail members serve as stops or rests for a second horizontal segment of each of the inverted question mark-shaped portions of the wire divider members, the second horizontal segment extending parallel to the horizontal end segment, supporting the wire divider member in either a rearwardly-inclined position or a forwardly-inclined position.

Each of the wire divider members are preferably removable from the base of the document sorting apparatus by the user. The ability to remove individual wire divider members provides convenient customizability, so as to increase the space between two adjacent wire divider members and accommodate relatively thick documents, files or the like. Alternately, the wire divider members may be permanently secured to the base of the document sorting apparatus.

In a preferred embodiment, the wire divider members have sufficient elasticity or flexing characteristics to enable them to be stretched for purposes of insertion of the horizontal end segments into the corresponding apertures in the side rails, then relax or recoil to a position wherein the horizontal end segments are retained in engagement with the side rails. Alternately, the side rail members may be separated from one another by one or more flexible elements that allow the side rail members to be compressed toward one another so as to accept the horizontal end segments of inflexible wire divider members in the apertures of the side rails.

Various materials may be used in the manufacture of the base of the document sorting apparatus, including but not limited to bent sheet metal, injection molded plastic, wood or fiber board, fabricated plastic sheet stock, formed metal mesh with metal trim, cold-cast resin, rubber or a combination of materials.

### BRIEF DESCRIPTION OF SEVERAL VIEWS OF THE DRAWING

FIG. 1 is a perspective view of a document sorting apparatus of the present disclosure;

FIG. 2 is a side plan view of the document sorting apparatus shown in FIG. 1;

FIG. 3 is a front plan view of the document sorting apparatus shown in FIG. 1;

FIG. 4 is a perspective view of the document sorting apparatus of FIG. 1, having an alternate floor member;

FIG. 5 is a top view of the document sorting apparatus shown in FIG. 4;

FIG. 6 is a bottom view of the document sorting apparatus shown in FIG. 4;

FIG. 7 is a left side plan view of the document sorting apparatus shown in FIG. 1, with all of the wire divider members shown in a rearwardly-inclined orientation;

FIG. 8 is a right side plan view of the document sorting apparatus shown in FIG. 1, with all of the wire divider members shown in a rearwardly-inclined orientation;

FIG. 9 is an exploded view of a document sorting apparatus of the present disclosure;

FIG. 10 is a perspective view of a document sorting apparatus of the present disclosure having lateral projections on side rail members thereof;

FIG. 11. is an enlarged perspective view of the area of FIG. 10 designated by “FIG. 11/13”;

FIG. 12 is a cross-sectional view taken along lines 12-12 of FIG. 11, with the wire divider member shown in phantom lines in forwardly-inclined and rearwardly-inclined orientations;

FIG. 13 is all enlarged side plan view of the area of FIG. 10 designated by “FIG. 11/13”;

FIG. 14 is a perspective view of an underside of a base of the sorting apparatus of FIG. 11;

FIG. 15 is a perspective view of a side rail member of the sorting apparatus of FIG. 1;

FIG. 16 is an end view of the side rail member of FIG. 15;

FIG. 17 is a perspective view of a second embodiment of a document sorting apparatus of the present disclosure;

FIG. 18 is a perspective view of a third embodiment of a document sorting apparatus of the present disclosure, the document sorting apparatus of this embodiment being inclined;

FIG. 19 is an enlarged side plan view of a portion of an inclined document sorting apparatus of the type shown in FIG. 18, including a lateral projection of a side rail of the document sorting apparatus; and

FIG. 20 is a cross-sectional view taken along lines 20-20 of FIG. 19.

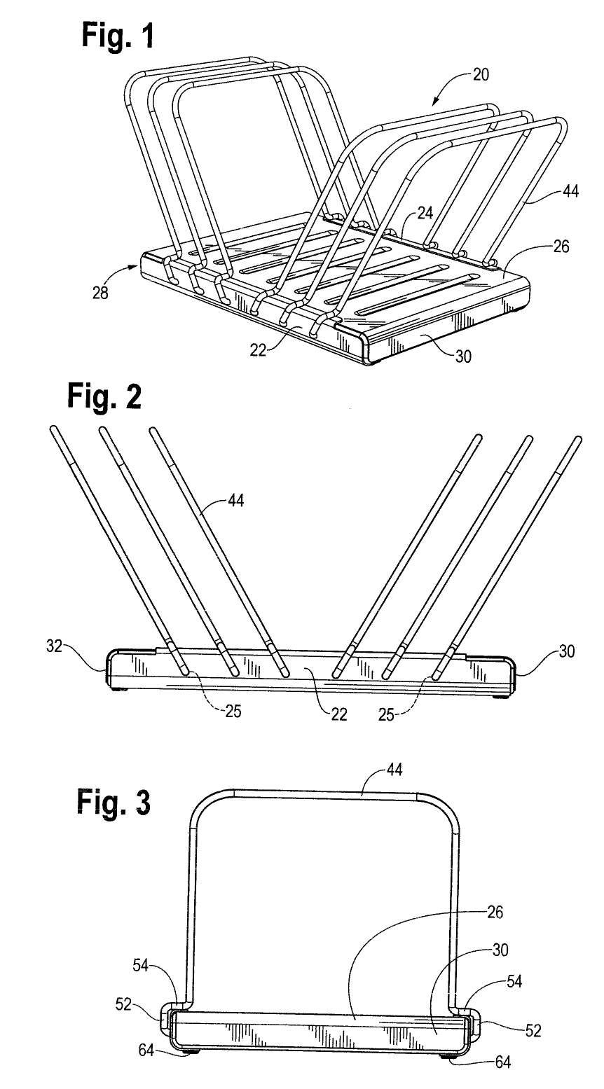

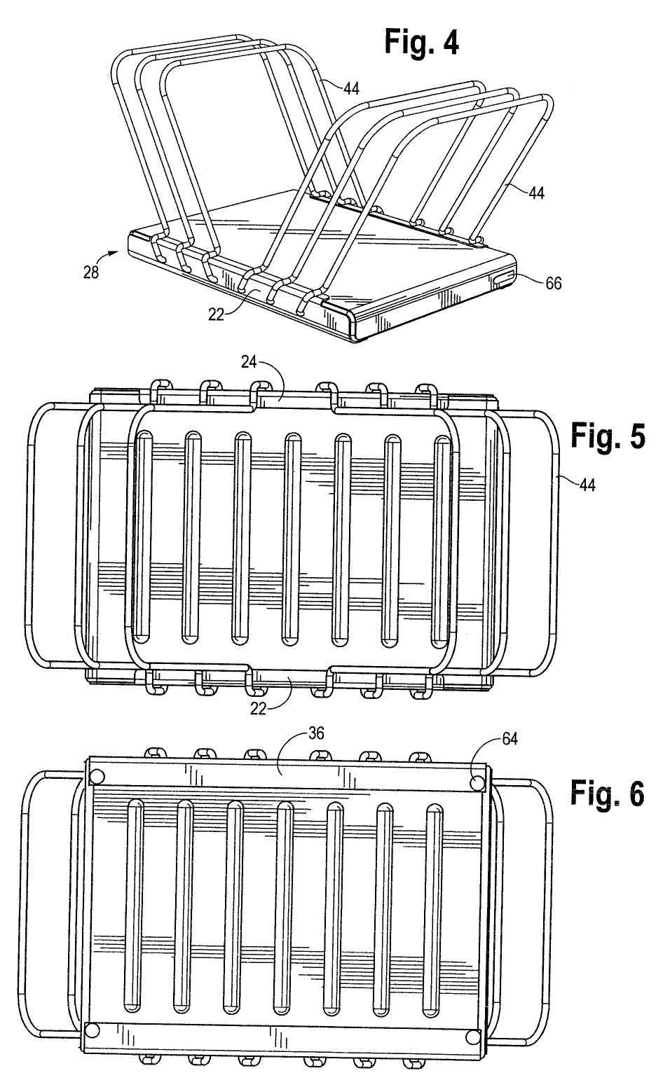

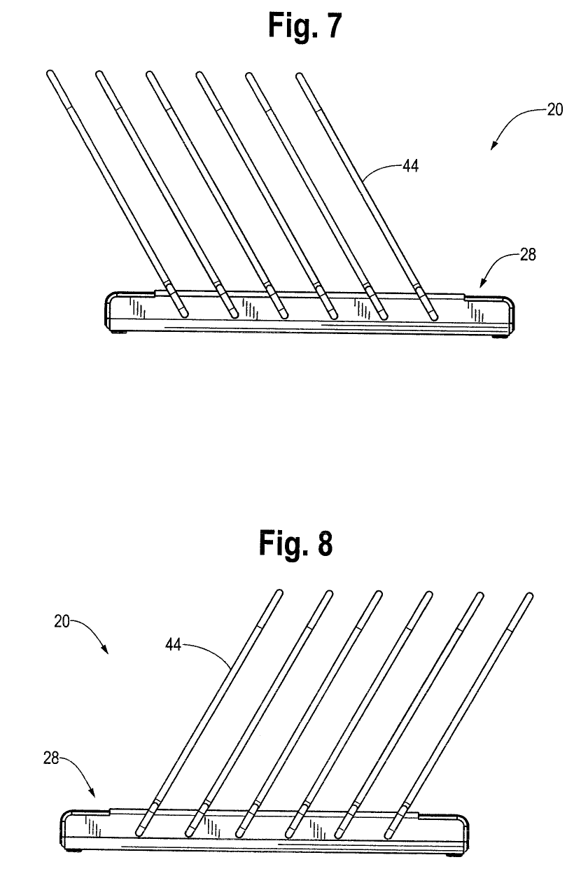

### DETAILED DESCRIPTION OF THE PREFERRED EMBODIMENTS

A document sorting apparatus 20 of the present disclosure has a pair of parallel, spaced-apart side rail members 22, 24. Each of the side rail member 22, 24 has a plurality of apertures 25 therein, distributed in a linear fashion along the length of the side rail member 22, 24, and each aligned with a corresponding aperture 25 in the opposite side rail member 24, 22.

In a first embodiment, the side rail members 22, 24 are spaced from one another by a floor member 26, with the side rail members 22, 24 and the floor member 26 defining a base 28 of the document sorting apparatus 20. The side rail members 22, 24 may be formed integrally with the floor member 26. Alternatively, the side rail members 22, 24 may be formed as separate structural components from the floor member 26 that have complementary details to facilitate securing these components to one another. For example, the floor member 26 may be provided with a downwardly-directed front rib 30 along a front end thereof, and a downwardly-directed rear rib 32 along a rear end of the floor member 26. Each of the side rail members 22, 24 may have an elongate upper lip 34 along a top edge of thereof, extending in a direction toward the opposing side rail member 24, 22. The elongate upper lips 34 extend over the top of the floor member 26. Each of the elongate upper lips 34 may extend continuously along substantially the entire length of the side rail member 22, 24, or over only segments thereof. An elongate lower lip 36 extends along a bottom edge of each of tie side rail members 22, 24. The elongate lower lip 36 of each side rail member 24 may be wider, i.e. extend more toward the opposite side rail member, then the elongate upper lip 32. For example, the elongate lower lip 36 may have a width of about 0.75 inch, and the elongate upper lip 34 may have a length of about 0.43 inch. The elongate lower lips 36 extend at least at a front end 38 and at a rear end 40 of each of the side rail members 22, 24, but may extend the entire length of the side rail members 22, 24. The elongate lower lips 36 are vertically spaced from the elongate upper lips 34 a distance corresponding to a height of the front rib 30 and rear rib 32 of the floor member 26 such that the side rail members 22, 24 may receive the floor member 26 therebetween.

The spacing of the elongate lower lips 36 and the elongate upper lips 34 may be slightly less than the height of the front rib 30 and rear rib 32 of the floor member 26, so as to provide an interference fit between the side rail members 22, 24 and the floor member 26. In addition or as an alternative to an interference fit, the side rail members 22, 24 and the floor member 26 may be secured to one another by crimping, spot-welding or by adhesive.

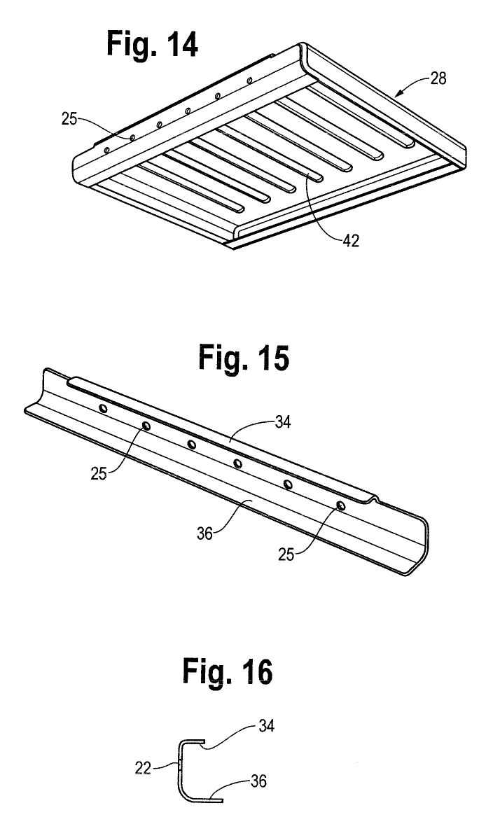

The floor member 26 may be formed of a variety of materials, including by way of example only, bent sheet metal, injection molded plastic, wood or fiber board, fabricated plastic sheet stock (transparent, translucent, or opaque), formed metal mesh with metal trim, cold-cast resin, rubber or a combination of materials. The floor member 26 may include a plurality of horizontal depressions 42, as best shown in FIG. 14, which is a perspective view taken from an underside of the floor member 26.

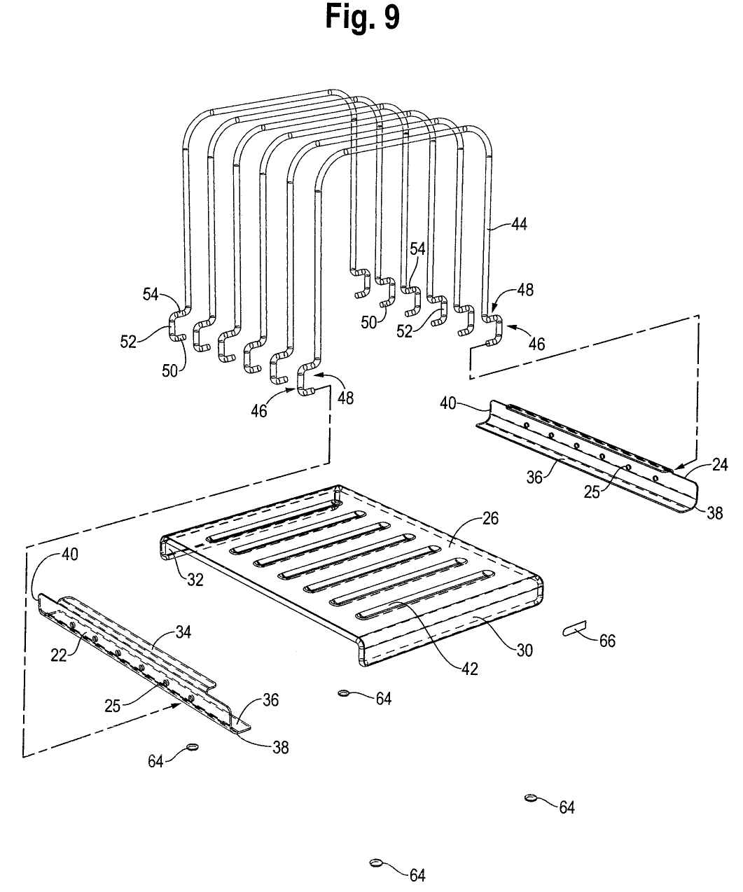

As best shown by dashed-lined arrows in the exploded view of FIG. 9, a plurality of sorting veins, preferably in the form of wire divider members 44, are received in the apertures 25 of the side rail members 22, 24. Each wire divider member 44 preferably forms an inverted U-shape (which could be a block-U or inverted rounded-U shape), with inverted block-question mark-shaped portions 46 at their lower ends 48 that point inwardly toward one another. The wire divider members 44 may have shapes other than an inverted U-shape. Each of the inverted question mark-shaped portions 46 includes, a lower end thereof, a horizontal end segment 50 engageable with one of the apertures 25 of the side rail members 22, 24, a straight segment 52 extending orthogonal to the horizontal end segment 50, and a second horizontal segment 54 extending parallel to the horizontal end segment 50, from an end of the straight segment 52 opposite the horizontal end segment 50 to a main leg portion 56 of the wire divider member 44.

The wire divider members 44 are preferably assembled to the base 28 by an end user, thereby minimizing dead-space in containers during shipping, and minimizing the volume of retail shelf space necessary to display a plurality of the document sorting apparatuses 20 for purchase. Once assembled to the base 28, each pair of adjacent wire divider members 44, together with the base 28, defines a discrete region for receiving and supporting documents therebetween. The diameter of each of the apertures 25 is at least slightly larger than the thickness of the horizontal end segment 50 of the wire divider member 44 received therein. For example, the apertures preferably have a diameter of 0.18 inch and the horizontal end segment 50 preferably has a diameter of 0.17 inch, providing 0.01 inch clearance. As a result, each of the wire divider members 44 is pivotally engaged with the side rail members 22, 24. The tops of the side rail members, i.e. the elongate upper lips 34, serve as stops or rests for the second horizontal segment 54 of each of the in-vented question mark-shaped portions 46 of the wire divider members 44. The second horizontal segments 54 support the wire divider member 44 in either a rearwardly-inclined position or a forwardly-inclined position.

By way of example, to achieve an angle of incline of the wire divider member 44 of 60° with respect to the side rail members 22, 24 (i.e., 30° with respect to a vertical plane, when the side rail members 22, 24 are parallel with a flat horizontal surface), the apertures 25 may be spaced approximately 0.59 inch (15.05 mm) from the top edge of each of the rail members 22, 24, and the straight segment 52 may have a height of approximately 0.61 inch (15.49 mm), with the straight segment 52 having radii of curvature of 0.09 inch (2.16 mm) with the horizontal end segment 50 and the second horizontal segment 52.

The wire divider members 44 are preferably sufficient elastic or flexible to enable them to be stretched for purposes of insertion of the horizontal end segments 50 into the corresponding apertures 25 in the side rail members 22, 24, then recoil to a position, preferably still in some degree of tension against the base 28, wherein the horizontal end segments 50 are retained in engagement with the side rails 22, 24. Preferably, even after assembly to the base 28, one or more of the wire divider members 44 may be easily removed from the base 28 by the end user, increasing the space between two adjacent wire divider members to accommodate relatively thick documents, files or the like. Alternatively, the wire divider members 44 may be permanently secured to the base 28, e.g. by forming the wire divider members 44 as continuous or substantially complete loops, or by bending an inner end of each of the horizontal end segments 50, alter insertion through the aperture 25, in a direction orthogonal to the horizontal end segment 50.

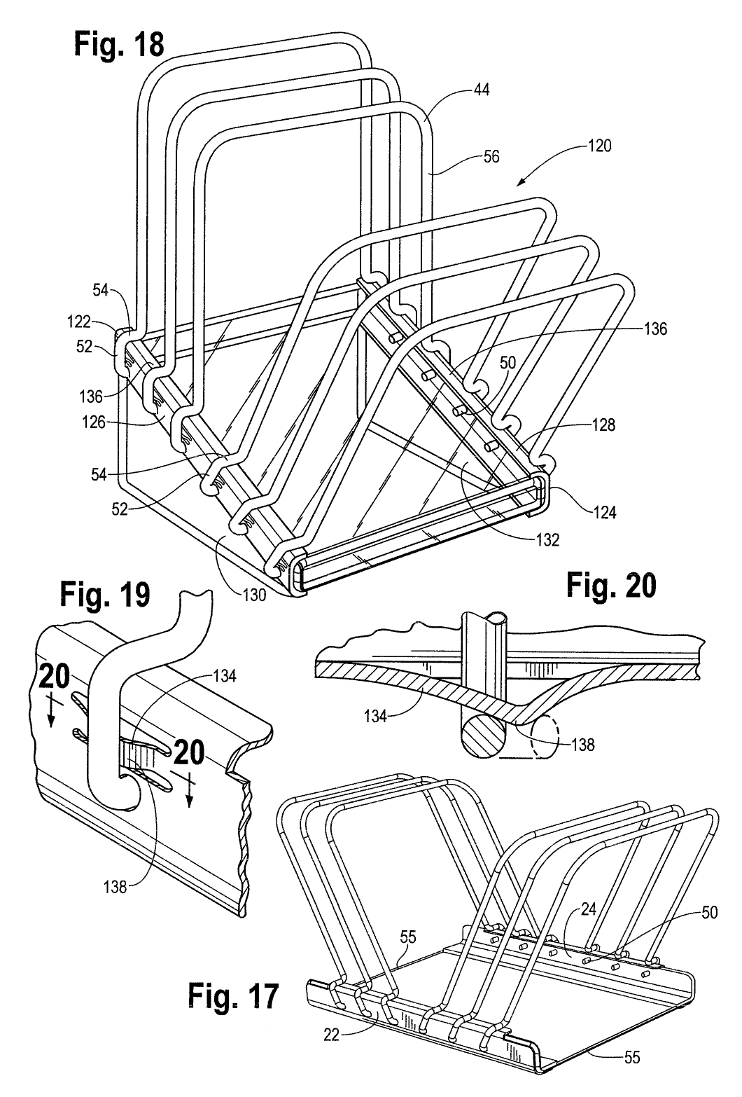

In, a second embodiment, as shown in FIG. 17, the side rail members 22, 24 may be separated from one another by one or more flexible cross-members 55, rather than by a floor member 26. In this second embodiment, as an alternative to flexible wire divider members 44 flexible cross-members 55 may be sufficiently flexible to allow the side rail members 22, 24 to be compressed toward one another so as to accept the horizontal end segments 50 of inflexible wire divider members 44 in the apertures of the side rails 22, 24.

While the apertures 25 may be evenly distributed along the side rails, the apertures 25 may instead be arranged at varying intervals, such as spaced more closely together toward the front ends of the side rail members 22, 24 and spaced farther apart toward the rear ends of the side rail members 22, 24. In such a, document sorting apparatus 20, when the wire divider members 44 are assembled to the base 28, the document-receiving regions between adjacent wire divider members 44 are larger toward the rear of the document sorting apparatus 20 than toward the front.

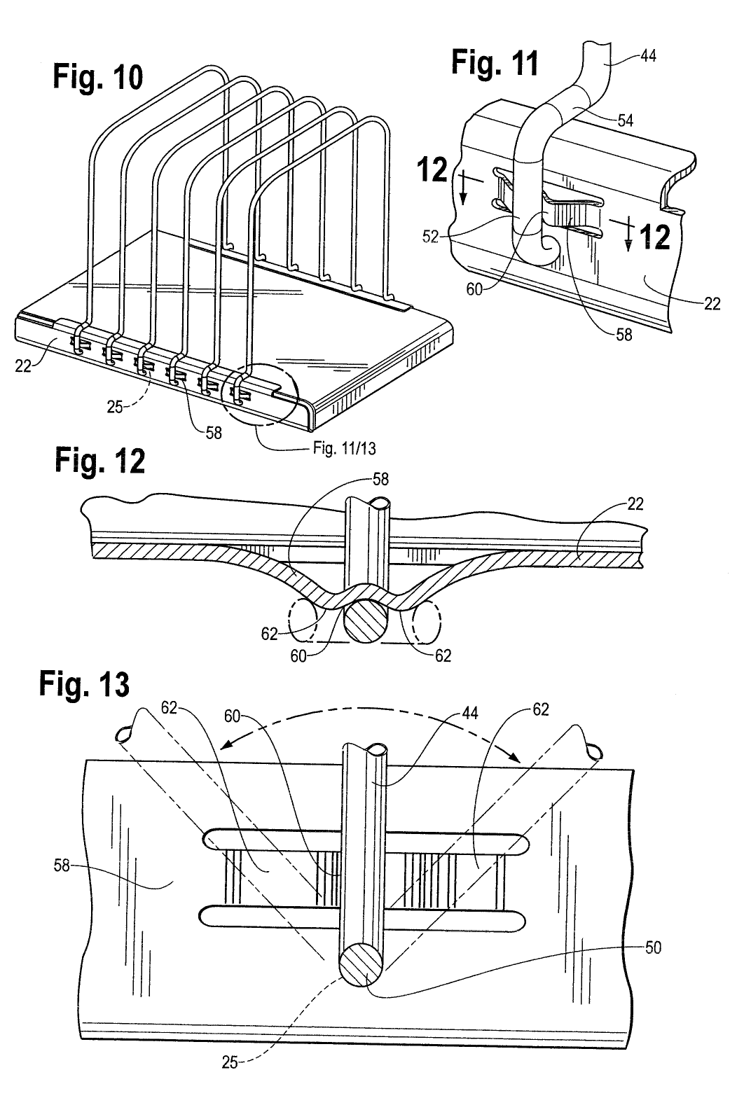

Turning to FIGS. 10-13, a document sorting apparatus 20 may include a lateral projection 58 above each of the apertures 25. Where the side rail members 22, 24 are formed of rolled or stamped sheet metal or the like, the lateral projections 58 may be stamped, pressed, punched, or some combination thereof. Each of the laterally-extending projections 58 includes a vertically-extending concave depression 60, i.e. a vertically-oriented dip, bounded by a pair of ridges 62. The ridges 62 of the laterally-extending projections 58 project away from an outer surface of the rail members a sufficient distance to impede, but not completely prevent, movement, i.e. pivoting, of the wire divider members 44 from one position to another. The vertically-extending concave depression 60 of the laterally-extending projection 58 accepts the straight segment 52 of the inverted block-question mark-shaped portion 46 of the wire divider member 44. When the straight segment 52 on either side of a given wire divider member 44 are so received in the vertically-extending concave depressions 60, the ridges 62 bounding each of the concave depression 60 serve to secure the wire divider member 44 in a vertical orientation.

Also, wheel the wire divider member 44 is in a rearwardly-inclined position, or at a forwardly-inclined position, the ridges 62 closest to the straight segments 52 tend to retain the wire divider member 44 in that rearwardly-inclined or forwardly-inclined orientation. Wire divider members 44 that are in tension when engaged with the apertures 25 of the side rail members 22, 24 enhance the securement of the wire divider members 44 in the given orientations. The tension of the wire divider members 44 and the resistance provided by the ridges 62 can be overcome with a deliberate, but minimal level of force exerted by a user on the wire divider member 44 in the desired direction of movement of the wire divider member 44. With about the same or only somewhat greater force, a plurality of wire divider members 44 can be pivoted to a desired orientation simultaneously.

The side rail members 22, 24 may be provided with anti-skid foot pads 64 on the bottoms thereof, such as on the elongate lower lip 36, serving to protect against scratching flat surfaces on which the document sorting apparatus 20 is placed, as well as avoid wobbling by limiting the points of contact between the document sorting apparatus 20 and the flat surface. The front rib of the floor member 26 may include a name plate 66 to display, for example, a logo or other indicia.

In a third embodiment, as illustrated in FIGS. 18-20, the document sorting apparatus 120 has a rear end 122 that is elevated relative to a front end 124. As such, the document sorting apparatus 120 functions as an inclined sorter. The side rail members 126 and 128 are each disposed on a respective sidewall 130, 132. Where the angle of incline of the side rail members 126, 128 and spacing of the apertures 25 from the top surface 136 of each of the side rail members 126, 128, the top surfaces 136 may stop straight segments 52 of the wire divider members 44 in a vertical orientation, preventing the wire divider members 44 from reaching a rearwardly-inclined position. Lateral projections 134 similar to the lateral projections 58 of the side rail members 22, 24 of the first embodiment may be provided in the side rail members 126, 128 of the inclined sorter of this third embodiment. Preferably, each of the lateral projections 134 includes at least one ridge 138, arranged to maintain the wire divider member 44 in the vertical position, or to resist (in a manner that is easily overcome by the user's application of deliberate force on the wire divider member 44) inadvertent movement of the wire divider member from a forwardly-inclined position to a vertical position.

Although certain embodiments of a document sorting apparatus have been described herein in accordance with the teachings of the present disclosure, the scope of coverage of this patent is not limited thereto. Modifications may be made to the disclosed embodiments that are still within the scope of the appended claims, either literally or under the doctrine of equivalents.

1. A document sorting apparatus comprising:
a base including a pair of parallel side rail members spaced apart from one another, each of the side rail members including a plurality of apertures therein, each of the apertures in one of the side rail members aligned with a corresponding one of the apertures in the opposite side rail member; and
a plurality of wire divider members, each of said wire divider members having a pair of horizontal end segments, said end segments pivotally engaged with one of the apertures in each of the side rail members.

2. The document sorting apparatus of claim 1, wherein each of the wire divider members includes a pair of straight segments, each of said straight segments extending orthogonal to a corresponding one of the horizontal end segments, and a pair of second horizontal segments, each of said second horizontal segments extending parallel to a corresponding one of the horizontal end segments.

3. The document sorting apparatus of claim 2, wherein each of the second horizontal segments of one of the wire divider members rests on a top surface of a corresponding one of the side rail members when the wire divider member is in an inclined position.

4. The document sorting apparatus of claim 3, wherein the top surface of each of the side rail members includes an elongate upper lip directed toward the opposite side rail member.

5. The document sorting apparatus of claim 1, further including a floor member disposed between the side rail members.

6. The document sorting apparatus of claim 5, wherein the top surface of each of the side rail members includes an elongate upper lip directed toward the opposite side rail member and the floor member includes a downwardly-depending front rib and a rear rib, the floor member being received under the elongate lower lips of the side rail members.

7. The document sorting apparatus of claim 6, wherein a bottom surface of each of the side rail members includes an elongate lower lip directed toward the opposite side rail member, and wherein the floor member is bounded on parallel sides by the elongate upper lips and the elongate lower lips of the side rail members.

8. The document sorting apparatus of claim 2, further including a lateral projection disposed above least one of the apertures, the lateral projection including at least one ridge tending to maintain a wire divider member engaged with the aperture above which the lateral projection is disposed in a vertical orientation when contacting the straight segment of the wire divider member.

9. The document sorting apparatus of claim 2, further including a lateral projection disposed above least one of the apertures, the lateral projection including a pair of ridges defining a vertical concave portion therebetween, the ridges tending to maintain a wire divider engaged with the aperture above which the lateral projection is disposed in a vertical orientation when the straight segment of the wire divider member is received in the vertical concave portion.

10. The document sorting apparatus of claim 1, wherein the parallel side rail members are each disposed on an inclined wall member such that a rear end of each of the side rail members is higher than a front end of each of the side rail members.

11. The document sorting apparatus of claim 1, wherein each of the wire divider members is sufficiently flexible to enable the horizontal end segments thereof to be temporarily flexed apart from one another to facilitate engagement or disengagement of the wire divider members and the apertures of the side rail members.

12. The document sorting apparatus of claim 1, wherein the side rail members are separated from one another by a flexible cross-member, and the side rail members may be temporarily compressed toward one another to facilitate engagement or disengagement of the wire divider members and the apertures of the side rail members.

13. A document sorting apparatus comprising:
a base including a pair of parallel side rail members spaced apart from one another, each of the side rail members including a plurality of apertures therein, each of the apertures in one of the side rail members aligned with a corresponding one of the apertures in the opposite side rail member;
a plurality of wire divider members, each of said wire divider members having a pair of horizontal end segments, said horizontal end segments pivotally engaged with one of the apertures in each of the side rail members,
said side rail members including means for selectively securing the wire divider members in a vertical position.

14. The document sorting apparatus of claim 13, wherein the means for selectively securing the wire divider members in a vertical position includes a lateral extension disposed above each aperture of the side rail members, the lateral extensions each including at least one ridge that impedes the wire divider member engaged with the corresponding hole from pivoting past the ridge.

15. The document sorting apparatus of claim 13, wherein the parallel side rail members are each disposed on an inclined wall member such that a rear end of each of the side rail members is higher than a front end of each of the side rail members.

16. The document sorting apparatus of claim 13, wherein the means for selectively securing the wire divider members in a vertical position includes a lateral extension disposed above each aperture of the side rail members, the lateral extensions each including at pair of ridges defining a vertical concave portion therebetween, the ridges tending to maintain a wire divider engaged with the aperture above which the lateral projection is disposed in a vertical orientation when a segment of the wire divider member is received in the vertical concave portion by impeding the wire divider member from pivoting past the ridge.

17. The document sorting apparatus including a floor member extending between the side rail members.

18. A document sorting apparatus comprising:
a base including a pair of parallel side rail members spaced apart from one another, each of the side rail members including a plurality of apertures therein, each of the apertures in one of the side rail members aligned with a corresponding one of the apertures in the opposite side rail member; and
a plurality of wire divider members, each of said wire divider members pivotally engaged with one of the aligned pairs of the apertures in the side rail members, each of the wire divider members movable between at least a forwardly-inclined position, wherein a horizontal segment on each side of the wire divider member rests on a top surface of one of the side rail members, and a vertical position, and each of the wire divider members, together with the base and an adjacent one of the wire divider members, defining a discrete region for supporting documents.

19. The document sorting apparatus of claim 18, wherein each of the wire divider members is selectively removable from the side rail members.

20. The document sorting apparatus of claim 18, wherein the side rail members include means for securing each of the wire divider members in a vertical position.
